(19) United States
(12) Patent Application Publication
(10) Pub. No.: US 2006/0134346 A1
(43) Pub. Date: Jun. 22, 2006

(54) Method of manufacturing heating/cooling coil with nanometer silver coating layer

(76) Inventor: O-Kab Kwon, Seoul (KR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/128,419

(22) Filed: May 13, 2005

(30) Foreign Application Priority Data
Dec. 16, 2004 (KR) 10-2004-0107066

(51) Int. Cl. H05H 1/24

(52) U.S. Cl. 427/569

(57) ABSTRACT

Disclosed herein is a method of manufacturing a heating/cooling coil with a nanometer silver coating layer, in which vacuum deposition of nanometer silver is performed on the surface of a heating/cooling coil, thus preventing corrosion of aluminum, sterilizing heating/cooling gas and fluid, and maintaining high heat conductivity. The method includes feeding argon gas into a vacuum chamber at a pressure of 10⁻⁵-10⁻⁷ torr until the pressure in the vacuum chamber reaches 100² torr, applying high negative voltage (−500˜−5000 V) to nanometer silver particles serving as a target material so that cations of argon gas induced by glow discharge collide with the surface of the nanometer silver particles electrically charged to a cathode, to eject the nanometer silver particles in the form of atoms in vapor phase, and forming the nanometer silver particles in vapor phase into a nanometer silver coating layer on the surface of the heating/cooling coil. In the current invention, ion sputtering is used to coat the surface of the heating/cooling coil with nanometer silver, thereby effectively increasing corrosion resistance for a long time and further enhancing surface sterilization effects.

### BACKGROUND OF THE INVENTION

1. Field of the Invention

The present invention relates to a method of manufacturing a heating/cooling coil with a nanometer silver coating layer, and more particularly, to a method of manufacturing a heating/cooling coil with a nanometer silver coating layer, in which nanometer silver is vacuum deposited on the surface of a heating/cooling coil, thus preventing corrosion of aluminum, sterilizing heating/cooling gas and fluid, and maintaining high heat conductivity.

2. Description of the Related Art

With rapid industrialization, a vicious circle including the development of novel compounds, the generation of various contaminants in proportion to the production of such compounds, the appearance of various diseases due to such contaminants, and the development of vaccines for treatment of such diseases has continuously arisen.

Further, as standards of living increase and various consumer products and home appliances are improved, articles able to exhibit various functions have been manufactured. For example, there are wall paper and furniture which emit far infrared rays. Recently, high-quality home appliances are variously manufactured, and most of them have drastically increased durability, and thus, rarely break down.

In an air conditioner that is generally used as a home appliance, aluminum, a copper foil or a plastic sheet is applied to a heating/cooling coil to form a heat exchanger. Also, a copper pipe is used in components contacting a coolant and water, and the heat transfer area of the heat exchanger, which is to contact air, is enlarged to maximize the heat transfer with air so that the overall heat transfer coefficient is increased. To this end, a method of attaching a radiating fin to the surface of a copper pipe is generally employed.

To increase the efficiencies of the copper pipe and the radiating fin, there are widely used methods of corrugating the surface of a radiating fin, of cutting a radiating fin to form complicated air passages so that a warm current of air is formed to increase the heat transfer coefficient with air, and of applying a hydrophilic coating agent on the surface of a radiating fin so that water drops are not formed on the surface of the fin and directly flow down to decrease air resistance and improve air flow.

As such, the hydrophilic coating agent is applied on the surface of aluminum which is a material for a heating/cooling coil, thus preventing the corrosion of the surface of aluminum and maintaining hydrophilic properties allowing water drops to efficiently flow down.

That is, the application of hydrophilic paint on aluminum using a dipping process or a spraying process is mainly performed to prevent the corrosion of an aluminum coil. In the technique used to prevent the corrosion of the radiating fin of the coil, although coating film thickness and coating quality depend on painting conducted by aluminum manufacturers, the prevention of corrosion of aluminum is never assured.

Coating techniques developed until now largely include surface coating. However, a painting process is considerably complex, and a coating film is difficult to form to a required thickness between the radiating fins. Further, the coating film may peel off after being used for a long time, and thus, the radiating fin and heating/cooling coil may easily corrode. Also, the coating process has shortcomings, such as low sterilization efficiency, and may contaminate indoor air.

Moreover, when the coating film is formed on the heating/cooling coil, it decreases heat conductivity of the heating/cooling coil, resulting in reduced heating/cooling efficiency.

### SUMMARY OF THE INVENTION

Accordingly, the present invention has been made keeping in mind the above problems occurring in the related art, and an object of the present invention is to provide a method of manufacturing a heating/cooling coil with a nanometer silver coating layer, in which nanometer silver is vacuum deposited on the surface of a heating/cooling coil, thus preventing corrosion of aluminum constituting the coil, sterilizing heating/cooling gas and fluid, and maintaining high heat conductivity.

In order to accomplish the above object, the present invention provides a method of manufacturing a heating/cooling coil with a nanometer silver coating layer, which comprises feeding argon gas into a vacuum chamber at a pressure of 10⁻⁵-10⁻⁷ torr until the pressure in the vacuum chamber reaches 100² torr, applying high negative voltage (−500˜−5000 V) to nanometer silver particles serving as a target material so that cations of the argon gas induced by glow discharge collide with the surface of the nanometer silver particles electrically charged to a cathode, to eject the nanometer silver particles in the form of atoms in vapor phase; and forming the nanometer silver particles in vapor phase into a nanometer silver coating layer on the surface of a heating/cooling coil.

Preferably, the method of manufacturing a heating/cooling coil with a nanometer silver coating layer is provided, characterized in that the heating/cooling coil is 50-200 μm thick.

Preferably, the method of manufacturing a heating/cooling coil with a nanometer silver coating layer is provided, characterized by further comprising applying hydrophilic paint on the heating/cooling coil, before the heating/cooling coil is coated with nanometer silver. In addition, a heating/cooling coil with a nanometer silver coating layer is provided, which is manufactured by the above method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the internal structure of a heating/cooling heat exchanger, according to the present invention;

FIG. 2 is a view showing the sputtering of nanometer silver ion clusters on the heating/cooling coil, according to the present invention; and

FIGS. 3a, 3b, 4a and 4b are views showing the hydrophilic and bacterial culture tests for the heating/cooling coil with a nanometer silver coating layer, according to the present invention.

### DESCRIPTION OF THE PREFERRED EMBODIMENTS

Hereinafter, a detailed description will be given of the present invention, with reference to the appended drawings.

In the present invention, a method of manufacturing a heating/cooling coil with a nanometer silver coating layer is provided, which includes vacuum depositing nanometer silver on the surface of a heating/cooling coil, thus preventing corrosion of aluminum, sterilizing heating/cooling gas and fluid, and maintaining high heat conductivity.

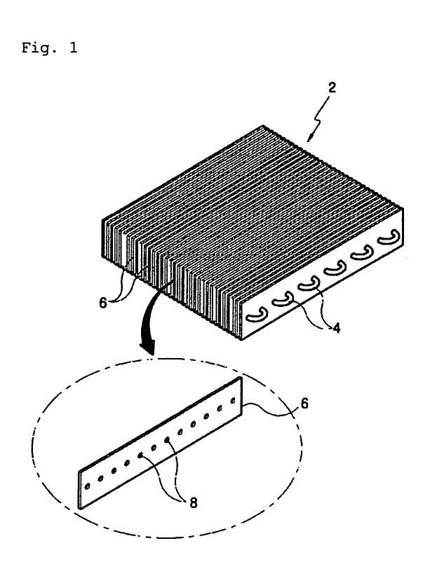

FIG. 1 is a view showing the internal structure of a heating/cooling heat exchanger, according to the present invention.

As shown in FIG. 1, the heat exchanger 2 on which vacuum deposition of nanometer silver is performed includes a heating/cooling pipe 4 for passing heating/cooling fluid therethrough, and a plurality of heating/cooling coils 6 laminated perpendicular to the heating/cooling pipe 4 and having insertion holes 8 through which the heating/cooling pipe 4 passes, to increase the surface area of the heating/cooling pipe 4 that is in contact with air.

Generally, the heating/cooling coil 6, which is formed of an aluminum foil, has a coating film formed by applying paint on the heating/cooling coil 6. However, almost all of the coating film is formed of a material harmful to human beings, and also, may easily peel off after use for a long time, so that the internal metal (aluminum foil) may corrode.

Hence, the method of manufacturing the heating/cooling coil with a nanometer silver coating layer, according to the present invention, includes vacuum depositing nanometer silver on the heating/cooling coil 6.

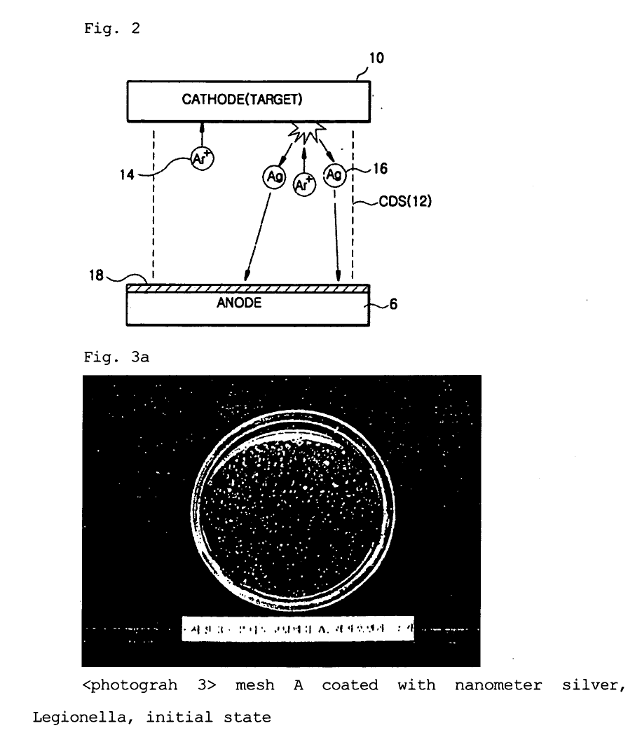

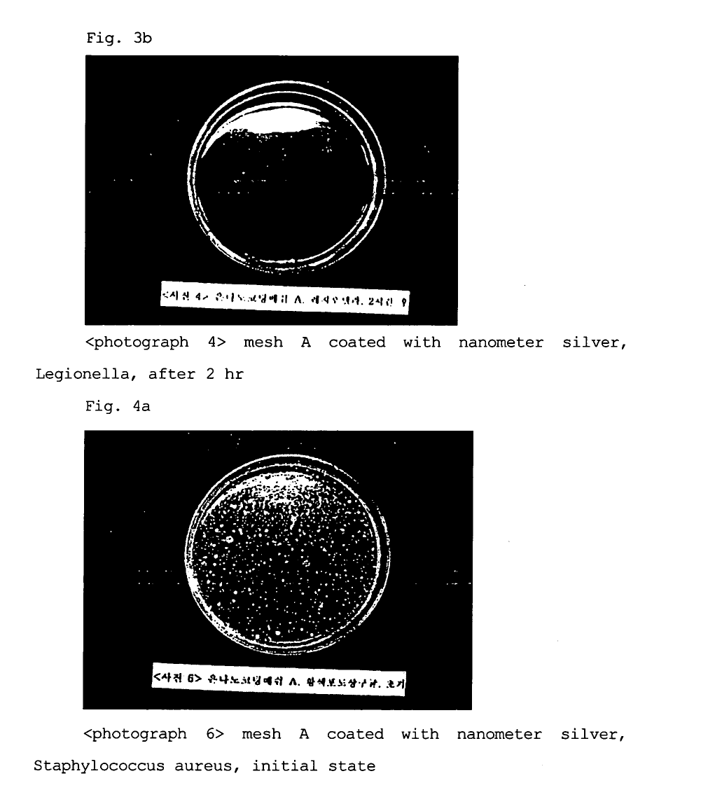

FIG. 2 is a view showing the sputtering of nanometer silver ion clusters onto the heating/cooling coil, according to the present invention, and FIGS. 3a and 3b are views showing the hydrophilic and bacterial culture test results for the heating/cooling coil with a nanometer silver coating layer, according to the present invention.

As shown in the drawing, the nanometer silver ion clusters are sputtered on the heating/cooling coil 6. As such, a sputtering process is extensively used in the semiconductor industry, and also, may be used to shield against electromagnetic waves depending on end purposes. Sputtering is typically driven by momentum exchange between high-energy ions and atoms in a solid target, due to complete elastic collision of the ions with the surface of the solid target, thus ejecting the atoms from the surface.

In this way, when the ion material having kinetic energy greater than the binding energy of atoms collides with the target, interlattice atoms in the target are displaced from their lattice sites due to ion collision, and then ejected from the surface of the target. This phenomenon is called sputtering in the fields of physics.

The sputtering for thin film deposition includes two steps, that is, ejection of atoms of a target and attachment of the ejected atoms to a substrate.

According to the principle of sputtering, when direct current (DC) power (1 W/cm²) is supplied to a target (cathode) with argon (Ar) gas serving as sputtering gas flowing in a vacuum chamber, plasma is induced between the substrate to be treated (object to be coated) and the target. Such plasma is accelerated toward a cathode by a high output DC system and collides with the surface of the target. Due to collision energy, the atoms of the target are ejected.

As such, the ejection of the target material is referred to as ‘sputtering’, which is used to chemically modify a material such as metal, plastic or glass. That is, using the principle of easily evaporating a metal in a vacuum, when a metal is heated in a vacuum, it is evaporated, scattered, and attached to a material placed in a vacuum, to form a metallicized thin film.

Sputtering is classified into an RF sputtering process, a magnetron sputtering process, an ion sputtering process, etc. Among these processes, any process may be utilized to increase the surface ionization depending on end purposes.

In the present invention, vacuum deposition of nanometer silver on the heating/cooling coil may be performed using any process selected from among an RF sputtering process, a magnetron sputtering process, and an ion sputtering process. In particular, an ion sputtering process or an RF sputtering process is preferably used.

Hereinafter, the process of vacuum depositing nanometer silver on the heating/cooling coil is described using ion sputtering.

In ion sputtering, argon gas able to create plasma is fed into a vacuum chamber until the pressure in the vacuum chamber, which is initially maintained at 10⁻⁵-10⁻⁷ torr, the same as in conventional vacuum deposition, reaches 100² torr. Also, high negative voltage (−500˜−5000 V) is applied to a target material, which is then made a cathode. In this case, the region of argon gas-fed plasma state is referred to as CDS 12.

Cations 14 of inert gas having high energy (1000 eV) induced by normal glow discharge collide with the surface 10 of nanometer silver particles, serving as a target material electrically charged to a cathode, to eject nanometer silver in the form of atoms 16 in vapor phase. The vapor phase having energy of about 10-40 eV higher than that of conventional vacuum deposition is transferred toward an object (heating/cooling coil 6) to be treated, and then condensed to form a surface coating layer 18.

Further, the above method includes the step of surface treating an air conditioning fin, which is previously prepared, to manufacture the heating/cooling coil. The fin sputtered with nanometer silver is used to manufacture the cooling coil. Thereby, the cooling coil has high heat transfer efficiency, and as well, exhibits hydrophilic, antifouling, deodorizing and sterilizing properties of the surface thereof.

Preferably, a heating/cooling coil 6 (100% aluminum foil) and an aluminum foil coated with hydrophilic paint are used, which have a thickness of 50 to 200 μm.

In the sputtering of ion clusters used for the method of the present invention, the atoms ionized in the state of a plasma by particles having energy are accelerated and hit the target material (nanometer silver particles), whereby the nanometer silver atoms are ejected and thus deposited on the substrate (heating/cooling coil 6) to be coated. In this way, the useful sputtering process is exemplified by ion sputtering, in which the surface of a solid is roughened by particles having energy to eject the material from the surface of the solid due to momentum exchange.

Hence, inert argon gas forms a plasma by glow discharge on the substrate (aluminum foil), and ion bombardment, that is, collision of argon ions with the surface of the target material which is a cathode, is caused, thus ejecting the nanometer silver particles in vapor phase.

This process forms the vapor phase not by chemical or thermal reaction but by a mechanical procedure (using momentum), and therefore, it is advantageous because any material may be used as a target material. As for sputtering, a DC process is typically used, but an RF potential of an AC process may be used for a nonconductive target material. The sputtering of ion clusters realizes the pure thin film deposition to a desired size through stable nanostructured clusters.

Before coating, the object serving as an anode undergoes glow discharge. Accordingly, it is possible to remove oxides and impurities from the surface by sputtering. Also, the adhesion of the coating layer is high due to activation of the surface.

Table 1, below, shows the sterilization effect of the heating/cooling coil 6 coated with nanometer silver particles by culturing Legionella and Staphylococcus aureus on the coil 6. FIG. 3a shows the state of strains when Legionella is first cultured on the heating/cooling coil 6 coated with nanometer silver particles, and FIG. 3b shows the state of strains after 2 hr.

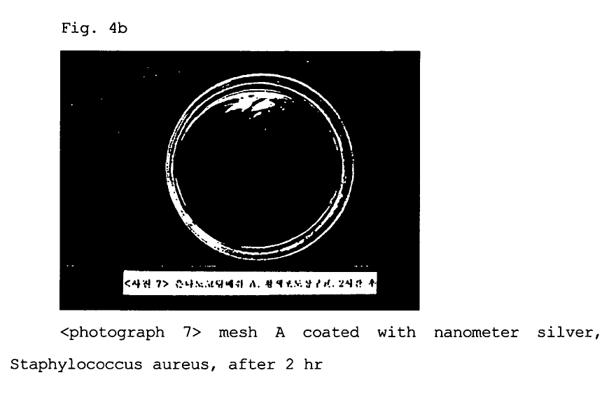

FIG. 4a shows the state of strains when Staphylococcus aureus is first cultured on the heating/cooling coil 6 coated with nanometer silver particles, and FIG. 3b shows the state of strains after 2 hr (tests were performed in Korea Environment & Water Works Institute).

TABLE 1

| | | | Initial | | |
|---|---|---|---|---|---|
| Test | | | Cell | After | After |
| Strain | Sample | Unit | Number | 2 hr | 7 days |
| Legion- | Heating/Cooling | CFU/ | 1.5 × 10³ | No | No |
| ella | Coil coated with | ml | | Detection | Detection |
| | Nanometer silver | | | | |
| | Control | CFU/ | 1.5 × 10³ | 1.5 × 10³ | 6.0 × 10⁸ |
| | | ml | | | |
| Staphy- | Heating/Cooling | CFU/ | 1.8 × 10³ | No | No |
| lococcus | Coil coated with | ml | | Detection | Detection |
| aureus | Nanometer silver | | | | |
| | Control | CFU/ | 1.8 × 10³ | 1.8 × 10³ | 7.2 × 10⁹ |
| | | ml | | | |

As the test results of culturing Legionella and Staphylococcus aureus on the heating/cooling coil 6 coated with nanometer silver of the present invention, it can be seen that no bacteria were detected after 2 hr or after 7 days. However, it appears that a general heating/cooling coil (control) has no sterilization effect after 2 hr and has drastically increased cell numbers after 7 days.

Although the preferred embodiment of the present invention for the method of manufacturing a heating/cooling coil with a nanometer silver coating layer has been disclosed for illustrative purposes, those skilled in the art will appreciate that various modifications, additions and substitutions are possible, without departing from the scope and spirit of the invention as disclosed in the accompanying claims.

As described hereinbefore, the present invention provides a method of manufacturing a heating/cooling coil with a nanometer silver coating layer. In the present invention, ion sputtering is used to coat the surface of a heating/cooling coil with nanometer silver, thereby effectively increasing the corrosion resistance of the coil for a long time, and further, enhancing surface sterilization effects of the coil.

What is claimed is:

1. A method of manufacturing a heating/cooling coil with a nanometer silver coating layer, comprising:
feeding argon gas into a vacuum chamber at a pressure of 10⁻⁵-10⁻⁷ torr until the pressure in the vacuum chamber reaches 100² torr;
applying high negative voltage (−500˜−5000 V) to nanometer silver particles serving as a target material so that cations of the argon gas induced by glow discharge collide with the surface of the nanometer silver particles electrically charged to a cathode, to eject the nanometer silver particles in a form of atoms in vapor phase; and
forming the nanometer silver particles in vapor phase into a nanometer silver coating layer on the surface of a heating/cooling coil.

2. The method as set forth in claim 1, wherein the heating/cooling coil is 50-200 μm thick.

3. The method as set forth in claim 1, further comprising applying hydrophilic paint on the heating/cooling coil, before the heating/cooling coil is coated with nanometer silver.

4. A heating/cooling coil with a nanometer silver coating layer, manufactured by the method of claim 1.
